(19) United States
(12) Patent Application Publication
(10) Pub. No.: US 2007/0079015 A1
(43) Pub. Date: Apr. 5, 2007

(54) Methods and arrangements to interface a data storage device

(75) Inventors: Robert J. Royer JR., Portland, OR (US); Amber D. Huffman, Banks, OR (US); Knut S. Grimsrud, Forest Grove, OR (US)

Correspondence Address: SCHUBERT, OSTERRIEDER & NICKELSON, PLLC;c/o Intellevate, P.O. BOX 52050, MINNEAPOLIS, MN, 55402, US

(73) Assignee: Intel Corporation

(21) Appl. No.: 11/240,055

(22) Filed: Sep. 30, 2005

(51) Int. Cl. G06F 3/00

(52) U.S. Cl. 710/5

(57) ABSTRACT

Methods and arrangements to interface a data storage device such as a small form factor IDE/ATA hard drive are disclosed. Embodiments may comprise a host and/or a data storage device. The host and data storage device may form, e.g., a handheld device such as an MP3 player, a cellular phone, or the like. The host may comprise a new interface referred to as a CE-ATA interface that facilitates interaction with the data storage device. In many embodiments, the CE-ATA interface combines an ATA command layer or emulator with a Multimedia Card (MMC) electrical interface, advantageously accommodating a fast time-to-market solution by leveraging existing technologies. More specifically, ATA commands may be mapped into an MMC register space to transmit the commands to the data storage device. Several embodiments also implement interrupt functions for the data storage device. Other embodiments may be disclosed and claimed.

### FIELD

The present invention is in the field of data storage. More particularly, the present invention relates to methods and arrangements to interface with a data storage device such as a small form factor Integrated Drive Electronics (IDE) or AT attachment (ATA) hard drive.

### BACKGROUND

The advent of low-cost, handheld products that utilize small hard drives such as personal digital assistants (PDAs), phones, and Moving Pictures Experts Group (MPEG) Audio Layer 3 (MP3) players, is driving the manufacturers of these small hard drives to find new and innovative ways to optimize the size and cost of the drives while decreasing the time-to-market [see ISO/IEC JTC1/SC29/WG11 MPEG, “International Standard IS 13818-3 Information Technology—Generic Coding of Moving Pictures and Associated Audio, Part 3: Audio”, published 1994; and ISO/IEC JTC1/SC29/JWG11 N1229, “MPEG-2 Backwards Compatible CODECS Layer II and III: RACE dTTb Listening Test Report”, Florence, published March 1996].

Key issues for designers relate to maintaining or even reducing the low pin count and optimizing the drive's interface for embedded applications of storage by, e.g., improving the electrical characteristics of the interface for the host. In particular, small hard drives, e.g., 1.8 inch, 1.0 inch, and 0.85 inch form factor hard drives, currently utilize a CompactFlash+ interface. standard, such as described in the CF+ and CompactFlash Specification Revision 3.0, published by the CompactFlash Association, Palo Alto, Calif., Dec. 23, 2004, http://www.compactflash.org. The CompactFlash+ interface is essentially a parallel ATA interface for small form factor Integrated Drive Electronics (IDE) or AT Attachment (ATA) drives.

The CompactFlash+ interface, however, presents problems with the design of future generations of products. The CompactFlash+ interface, for instance, is a 50-pin parallel. interface with a five-volt tolerance, which presents significant limitations to attempts to reduce pin counts for new, hand held products designed with an eye toward low power consumption. Furthermore, the high five-volt signaling requirement is becoming extremely challenging and cumbersome in successive generations of integrated circuits as geometries are scaled down, due to the inherent behaviors of the finer geometries.

### BRIEF DESCRIPTION OF THE DRAWINGS

Advantages of the invention will become apparent upon reading the following detailed description and upon reference to the accompanying drawings in which like references may indicate similar elements:

FIG. 1 depicts an embodiment of a system including a host and a data storage device;

FIGS. 2A-C depict embodiments of a CE-ATA command for the host of FIG. 1 including an example data structure and timing diagrams illustrating execution;

FIG. 3 depicts an embodiment of a timing diagram to illustrate interaction for an interrupt command initiated by a data storage device for a host such as the host and data storage device shown in FIG. 1;

FIG. 4 depicts an embodiment of a host interface and a data storage device interface to implement a CE-ATA interface with optional capabilities of generating and processing an interrupt;

FIG. 5 depicts a flowchart of an embodiment of a host interacting with a data storage device on a CE-ATA interface; and

FIG. 6 depicts a flowchart of an embodiment of a data storage device interacting with a host on a CE-ATA interface.

### DETAILED DESCRIPTION OF EMBODIMENTS

The following is a detailed description of embodiments of the invention depicted in the accompanying drawings. The embodiments are in such detail as to clearly communicate the invention. However, the amount of detail offered is not intended to limit the anticipated variations of embodiments, but on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, methods and arrangements to interface a data storage device such as a small form factor IDE/ATA hard drive are contemplated. Embodiments may comprise a host and/or a data storage device. The host and data storage device may form, e.g., a handheld device such as an MP3 player, a cellular phone, or the like. The host may comprise a new interface referred to as a Consumer-Electronics AT Attachment (CE-ATA) interface that facilitates interaction with the data storage device. In many embodiments, the CE-ATA interface combines an ATA command layer or emulator with a Multimedia Card (MMC) electrical interface, advantageously accommodating a fast time-to-market solution by leveraging existing technologies. More specifically, ATA commands may be mapped into an MMC register space. [See CE-ATA Digital Protocol specification revision 1.0, 02 Mar. 2005, http://www.ce-ata.org/]. [Also See MMC System Summary Specification v3.31, 26 May 2004, MultiMediaCard Association, P.O. Box 2012, Cupertino, Calif. 95015-2012, USA, http://www.mmca.org].

Many embodiments add one or more bulk data transfer MMC commands to issue ATA commands. In many embodiments, the MMC commands will transmit an ATA command of up to sixteen 8-bit registers, which would otherwise require multiple register writes, in one MMC transaction such as a read-write multiple register command, “RW_MULTIPLE_REGISTER”. The multiple registers are quickly transmitted across the parallel data lines rather than across the single command line. Such embodiments may advantageously offer a consistent ATA software infrastructure with at least some legacy software compatibility. Several embodiments also incorporate interrupt functions for the data storage device.

While portions of the following detailed discussion describes embodiments with reference to specific configurations and protocols, persons of ordinary skill in the art will recognize that embodiments may be implemented with other configurations and other protocols.

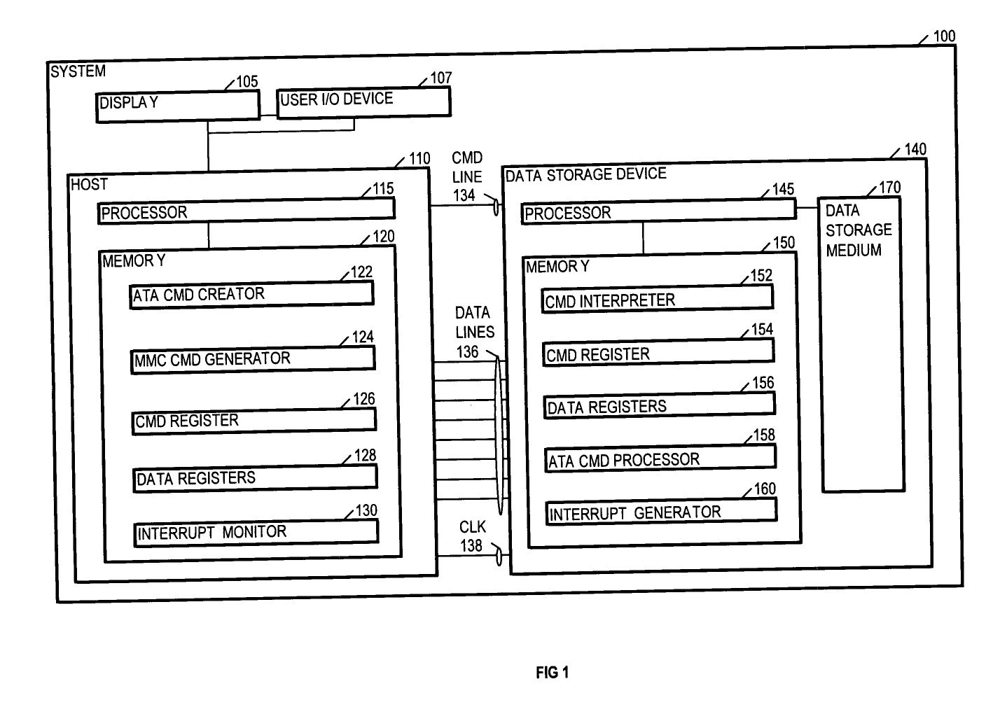

Turning now to the drawings, FIG. 1 illustrates an embodiment of a system 100 including a display 105, a user input-output (I/O) device 107, a host 110, and a data storage device 140. System 100 may be, e.g., a portable music player, a portable video player, a smartphone or other cellular phone, a digital video camera, a digital still camera, a personal digital assistant (PDA), an external storage device, or the like. Display 105 and user I/O device 107 may facilitate interaction between host 110 and a user. For example, user I/O device 107 may comprise a number pad, keyboard, joystick, microphone, speaker, and/or the other input-output devices.

Host 110 may comprise logic to perform a set of user functions to interface with a user and data on data storage device 140. For example, host 110 may request identification of data storage device 140 upon boot up to determine appropriate communication protocols. In particular, data storage device 140 may indicate that data storage device 140 is a CE-ATA (Consumer-Electronics AT Attachment) compliant device. Then, host 110 may interact with a user to play songs that are stored on data storage medium 160, receive and send text messages, display names and phone numbers stored on data storage medium 160, and dial phone numbers selected by the user from the numbers stored on data storage medium 160.

Host 110 may comprise a processor 115 coupled with memory 120. Processor 115 may execute microcode, Java™, or other instructions or logic to interact with the user and access information stored in data storage device 140. Memory 120 may comprise random access memory (RAM) such as dynamic random access memory (DRAM) to store instructions and data for execution by processor 115 as well as nonvolatile memory such as flash memory and/or read only memory (ROM). Memory 120 may also comprise a buffer to store data being read from and to be written to data storage device 140.

Memory 120 comprises coded logic, which, when executed by processor 115, implements functionality for system 100. In some embodiments, the code or at least part of the code may reside in firmware that may be updated on occasion and, in further embodiments, the code may reside in other non-volatile memory. In still other embodiments, part of the code may reside on a data storage medium 170 of data storage device 140. The code may then be loaded into memory 120 upon boot or some time after boot.

Memory 120 comprises an ATA command creator 122, an MMC command generator 124, a command register 126, data registers 128, and an interrupt monitor 130. The ATA command creator 122 comprises code for execution by processor 115 to generate an access for data storage device 140 in accordance with an ATA protocol. The logic of ATA command creator 122 may then map the ATA command in thirteen 8-bit registers in data registers 156. For example, ATA command creator 122 may produce a write command to store data on data storage medium 170.

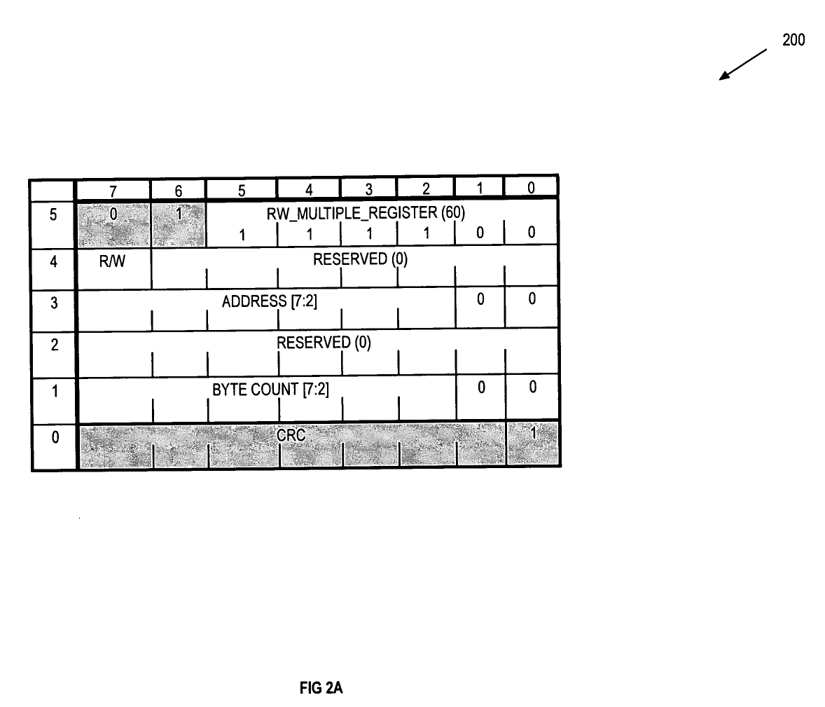

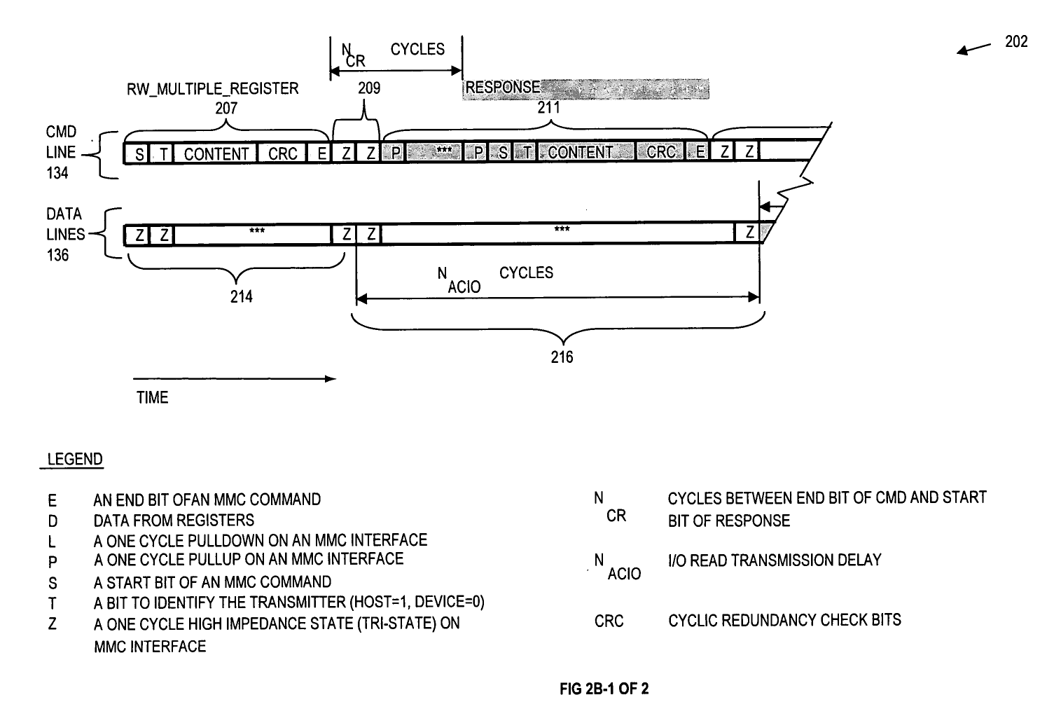

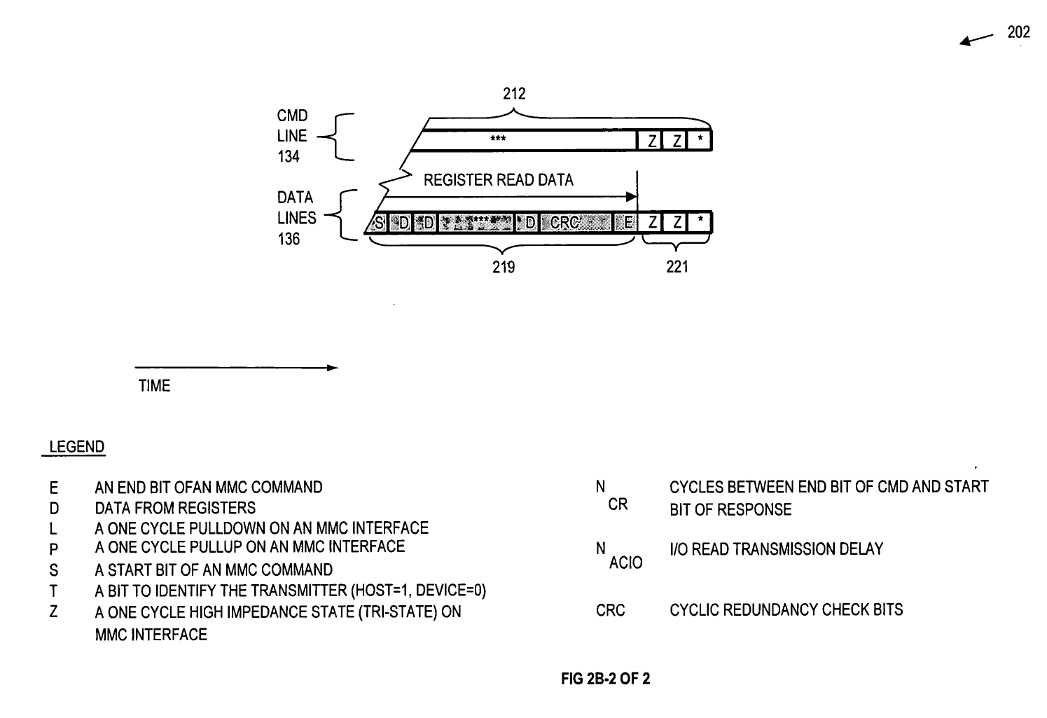

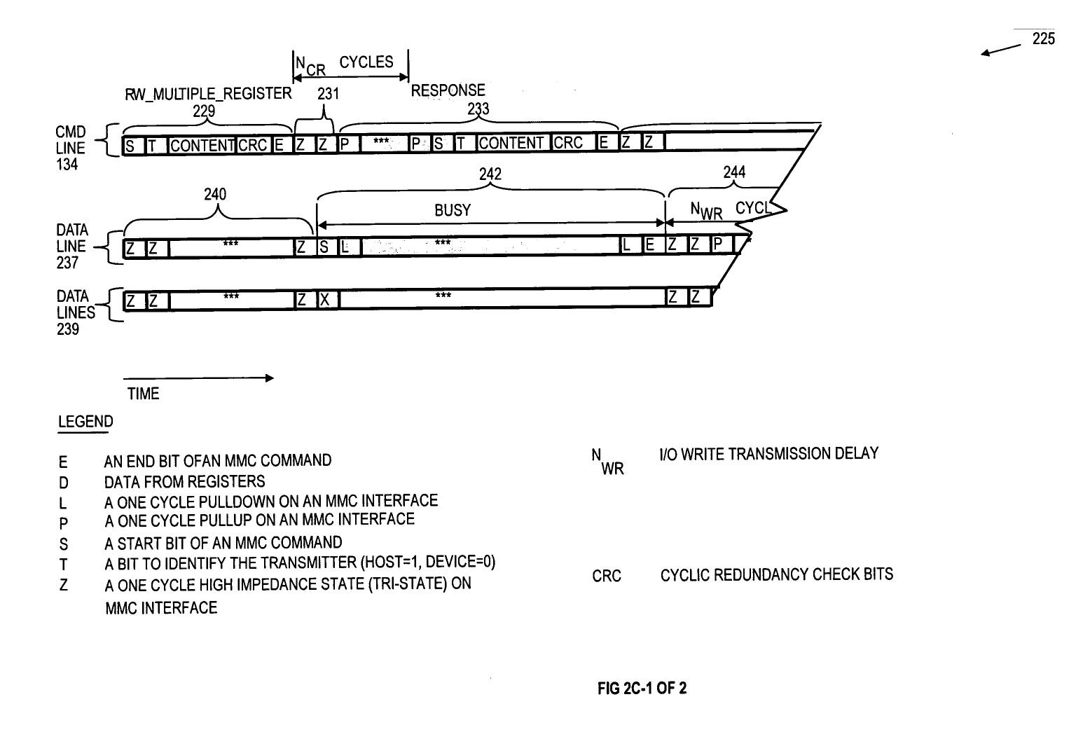

MMC command generator 124 may generate a command in command register 126 that is compatible with an MMC protocol and transmit the command from the command register 126 across a command line 134 to data storage device 140. Clock 138 may synchronize transmissions across command line 134 as well as data lines 136. FIG. 2A illustrates an embodiment of a data structure 200 for such an MMC command. Data structure 200 is adapted to transmit an ATA command from a data block in data registers 128 to data storage device 140 to access data storage medium 170. In particular, data structure 200 shows six registers as rows zero through five. Each register comprises eight bits, i.e., bits zero through seven. Register five comprises bits seven and six, which are the start bit and transmitter bit, respectively. The start bit and transmitter bit will transfer across command line 134 first, the zero bit indicating that a packet is about to be transferred and the one indicating that host 110 is transferring the packet. Bits five through zero of register five transmit next, identifying the command as a read-write multiple register command. Some embodiments comprise other bulk data transfer commands such as a read-write multiple block command.

The “RW” indicator at register four, bit seven comprises a flag to indicate whether the operation of the MMC command is a read from data registers 156 or a write to data registers 156. The “Address” indicator at register three, bits seven through two, may represent the starting register address for the MMC command. The “Byte Count” indicator at register one, bits seven through two, may represent the number of bytes to read from or write to data registers 156. And, the “CRC” indicator represents Cyclical Redundancy Checking bits that may be used to ensure the accuracy of transmission of the data of data structure 200 across command line 134. The end bit at bit zero of register zero demarks the end of the MMC command.

After host 110 issues a command from command register 126, interrupt monitor 130, upon execution by processor 115, may monitor command line 134 for an interrupt from data storage device 140. In many embodiments, data storage device 140 may issue a response to the command prior to issuing an interrupt so, in such embodiments, interrupt monitor 130 may begin monitoring for an interrupt after receipt of the response.

Interrupt monitor 130 may comprise logic to detect an interrupt signal placed on the command line by data storage device 140. In one embodiment, a general purpose I/O may be configured internally to recognize a change in state of the command line.

Data storage device 140 may be a small form factor ATA hard drive and may comprise a processor 145, a memory 150, and a data storage medium 170. Processor 145 may be designed to execute communications protocols and utilities such as error correction code (ECC) and remapping functions. Memory 150 may be volatile memory such as DRAM and non-volatile memory such as flash memory or ROM. Memory 150 comprises a command interpreter 152, a command register 154, data registers 156, an ATA command processor 158, and an interrupt generator 160.

The logic of command interpreter 152, when executed by processor 145, may identify an MMC command that transfers an ATA command across data lines 136 and, in response, indicate the receipt of the ATA command to ATA command processor 158. For example, upon receipt of the command shown in FIG. 2A, the command may be stored in command register 154. Command interpreter 152 may then read bits five through zero of register five to determine that the subsequent transfer across data lines 136 into data registers 156 will comprise an ATA command.

ATA command processor 158 may execute the ATA command stored in data registers 156 to perform the corresponding access of data storage medium 170. For instance, if the ATA command is a read command, ATA command processor 158 may read data from data storage medium 170 and store the data in data registers 156. Then, interrupt generator 160 may issue an interrupt to return a completion to host 110 that includes the data in data registers 156.

Interrupt generator 160 may be executed by processor 145 to issue an interrupt to host 110 to inform host 110 of a problem, issue a completion, or perform other functionality for which an interrupt may be beneficial. In some embodiments, the interrupt may comprise pulsing the command line 134 low. For example, if data storage device 140 encounters a problem interpreting a command from host 110 or during an attempt to execute such a command, data storage device 140 may pulse the command line low while the command line is not otherwise in use, to inform host 110 of the problem.

In further embodiments, interrupt generator 160 may issue the interrupt signal by storing a bit in command register 154. Such embodiments may depend upon an embedded clock or timer to determine the number of cycles that the bit remains on the command line 134. Further embodiments may reconfigure a general purpose input-output (I/O) coupled with command line 134 to issue an interrupt on the command line 134. Embodiments that employ hardware to issue the interrupt signal, on the other hand, may offer the advantage of more accurate timing.

Looking also to FIG. 2B, there is shown an embodiment of a timing diagram 202 for transmission of an ATA read command in a single transaction via the read-write multiple register MMC command illustrated in FIG. 2A. The latency for the transaction may include, for example, a 48-bit MMC command delivered at 13 MHz, which is 3.7 microseconds; up to 64 clocks of latency between the MMC command and response at 13 MHz, which is 4.92 microseconds; a 48-bit MMC response at 13 MHz, which is 3.7 microseconds; and a 128 bit data block (sixteen 8-bit register locations) written at 13 MHz on 4 data lines, which is 2.46 microseconds. Thus, the total latency of this single MMC transaction ATA command may be approximately 14.78 microseconds.

The timing diagram 202 illustrates the transmission of signals on the command line 134 and the data lines 136. Data lines 136 include lines 0-7. Timing diagram 202 begins with host 110 issuing a read-write multiple register command 207 from command register 126 onto command line 134. Host 110 maintains a high-impedance state “Z” 214 on the data lines 136 during issuance of the read-write multiple register command 207.

Once the command 207 is issued and after a number of cycles, Ncr cycles 209, starting from the end bit “E” of the command 207, data storage device 140 issues a response 211. The command line 134 may be placed in a high-impedance state “Z” during Ncr cycles 209 to avoid damage to a complementary pair of transistors used in a push-pull arrangement on the command line 134. Command interpreter 152 may identify the command 207 as a read-write multiple register command from the content of the command 207. Data storage device 140 may then issue a response 211 for the command 207 to host 110 across the command line 134.

The data lines 136 may remain in the high-impedance state “Z” Nacio cycles 216 until a couple of cycles after the end bit “E” of the response 211. After Nacio cycles 216, data storage device 140 may transfer the register read data 219 of data registers 156 to host 110. For example, after receiving command 207, ATA command processor 158 may store data retrieved in response to an ATA command from data storage medium 170 into data registers 156. Then, data storage device 140 may begin to transmit that data to host 110 in the third cycle after the end bit “E” of response 211. Data storage device 140 may also float the data lines 136 in a tri-state or high impedance state “Z” 221 after the transmission to facilitate a subsequent transaction.

Note that many embodiments take advantage of the long period 212 of the high-impedance state “Z” on the command line 134 to issue interrupt signals. In some embodiments, the command line may be weakly pulled high so that a pulse low for the interrupt is easily distinguishable from noise on the floating bus or drift of the floating bus.

Looking also to FIG. 2C, there is shown an embodiment of a timing diagram 202 for transmission of an ATA write command in a data block of a single MMC transaction. In particular, the ATA command is transmitted via the read-write multiple register command 229 illustrated in FIG. 2A. Host 110 initiates the transaction by issuing a RW_MULTIPLE_REGISTER command 229 with “WR” set to, e.g., a logical one to indicate a write. The command 229 will write from data registers 128 in host 110 to data registers 156 in data storage device 140. Data storage device 140 may respond within Ncr cycles 231 after the end bit “E” of the command 229 with a response 233. For instance, response 233 in the present embodiment pulls the command line 134 high “P” for a number of cycles, asserts a start bit “S” for the response 233, asserts a transmitter bit “T” indicative of data storage device 140 as the source of the packet, applies the content of the response 233 to the command line 134, and finishes the response 233 with CRC bits and an end bit “E”.

Two clocks after the end bit “E” of the command 229, data storage device 140 may, in the present embodiment, optionally assert MMC Busy 242 by pulling data line 237 low “L”, which is data line zero in this embodiment. Data storage device 140 may pull data line 237 low “L” until data storage device 140 is ready to receive the data block of data registers 128 from host 110. Within Nwr cycles 244 after the end bit “E” of response 233 and after MMC Busy 242 is deasserted, host 110 may start the data transmission, write register data 246, to data storage device 140. Host 110 may not start the write register data 246 to data storage device 140 before MMC Busy 242 is deasserted in the present embodiment.

If host 110 does not start the write register data 246 the cycle after MMC Busy 242 is deasserted, host 110 may pull the data lines 237 and 239 high “P”. The write register data 246 may be an MMC bulk data transfer containing data to be written to the registers specified in the command 229 followed by a CRC. Then, two cycles after the end bit “E” of the write register data 246, data storage device 140 may transmit the CRC status 250 for each data line to host 110 to indicate whether the CRC verified the data received from host 110. If the data on all data lines 237 and 239 were received successfully and the CRC calculations were correct, a positive CRC status 250 may be indicated by transmitting a signal such as 010b (hexadecimal) on data line 237. On the other hand, if the data on any data line 237 and 239 was not received successfully or had an incorrect CRC calculation, transmitting a signal such as 101b (hexadecimal) on data line 237 may indicate a negative CRC status 250.

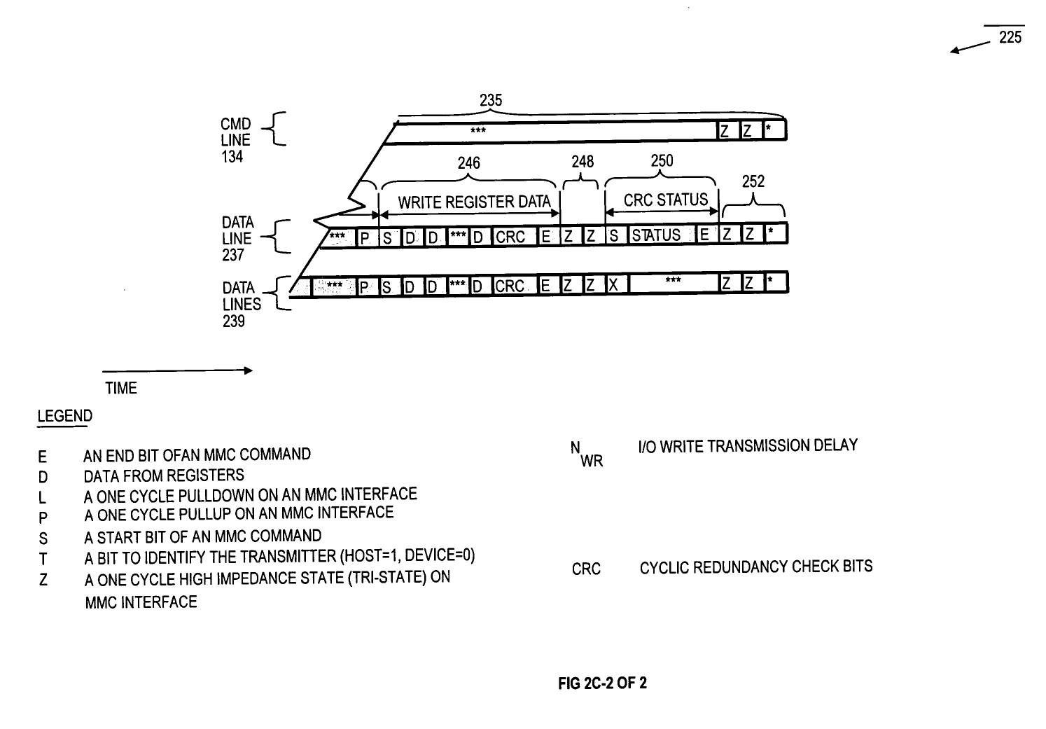

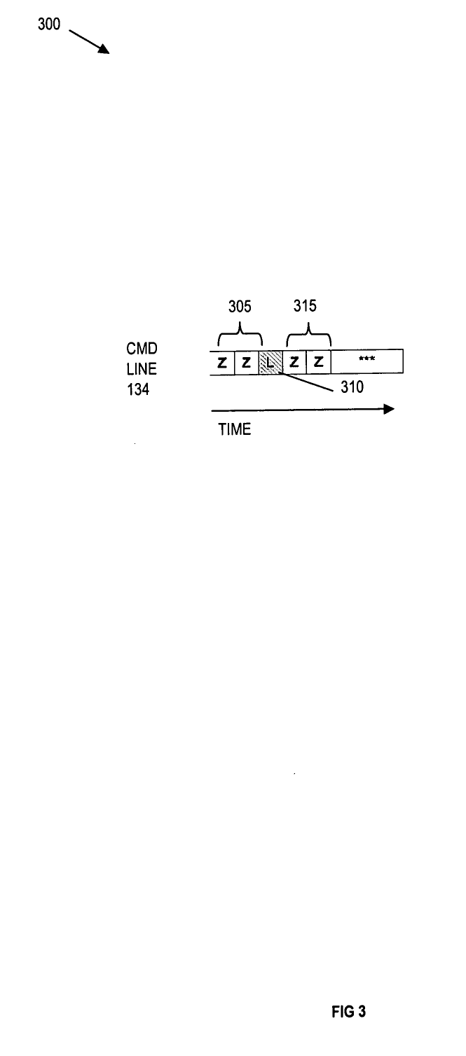

FIG. 3 depicts an embodiment of a timing diagram 300 to illustrate interaction for an interrupt command initiated by data storage device 140 for a host 110 as shown in FIG. 1. The timing diagram 300 illustrates an embodiment that asserts an interrupt signal on command line 134 although other embodiments may utilize data lines 136. In the present embodiment, the interrupt signal comprises one cycle 310 in which data storage device 140 pulls command line 134 low “L”. The high-impedance “Z” cycles 305 and 315 are buffers to avoid ill effects related to host 110 pulling the command line 134 high “P” when data storage device 140 is pulling the command line 134 low “L”. And, in many embodiments, the interrupt may be implemented at some point after the end bit “E” of a response such as responses 211 and 233 of FIGS. 2B-C.

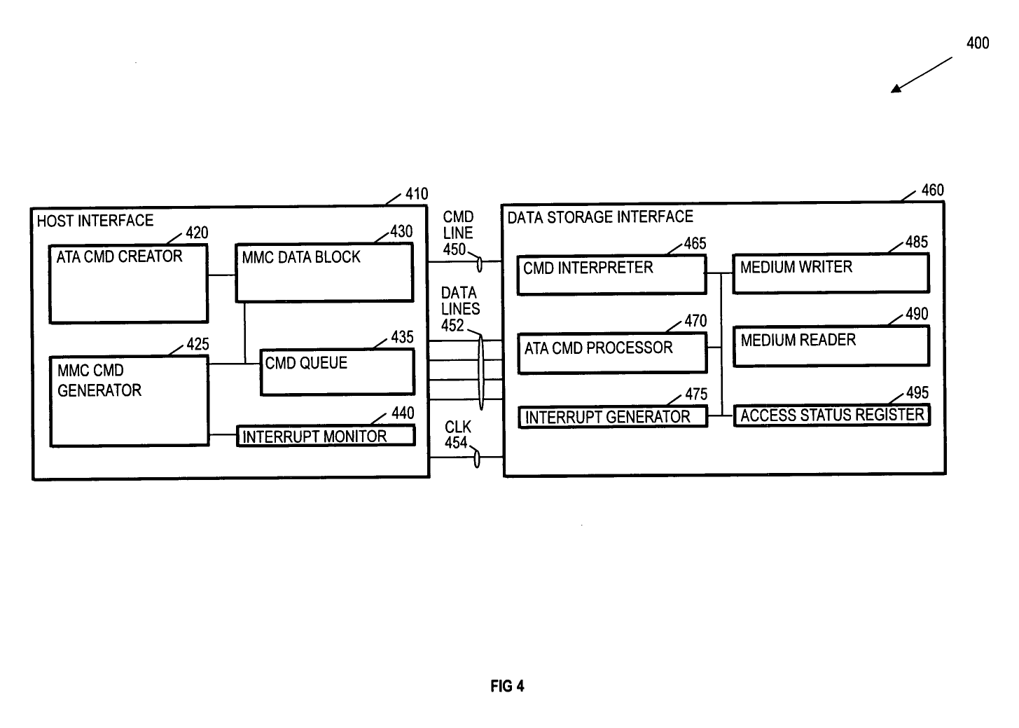

FIG. 4 depicts an embodiment 400 of a host interface 410 and a data storage device interface 460 to implement a CE-ATA interface with capabilities of generating and processing an interrupt. Host interface 410 and data storage interface 460 may comprise logic such as software, firmware, other code, processors, and/or state machines to facilitate interaction between a host and a data storage medium. For example, host interface 410 may communicate with data storage interface 460 to retrieve the text of an email to display for a user.

Host interface 410 comprises an ATA command creator 420, an MMC command generator 425, an MMC data block 430, a command queue 435, and an interrupt monitor 440. ATA command creator 420 may create an ATA command to satisfy an access request for a host. ATA command creator 420 may be a state machine or other logic designed to produce an ATA command in accordance with an ATA protocol and store the command in MMC data block 430. In some embodiments, ATA command creator 420 may include logic to create read commands, write commands, and other ATA access commands such as storage medium maintenance commands.

MMC command generator 425 may generate MMC commands to communicate with data storage interface 460. For example, MMC command generator 425 may generate a command to transfer ATA commands across data lines 452 and store the command in command queue 435 to initiate the transaction. Host interface 410 may then issue the command across the command line 450 and transmit the ATA command across data lines 452. Clock 454 may synchronize transmissions across both command line 450 and data lines 452. In several embodiments, host interface 410 may await a response from data storage interface 460 prior to transmission of the ATA command across data lines 452. In further embodiments, data storage interface 460 may assert a busy signal on one or more of the data lines 452 to delay transmission of the ATA command.

Interrupt monitor 440 may monitor the command line 450 for a signal from data storage interface 460 that is indicative of an interrupt. For example, in some embodiments, the data storage interface 460 may pull the command line high or low to transmit the interrupt to host 410. In other embodiments, data storage interface 460 may assert a sequence or bits or transitions to transmit an interrupt to host interface 410.

Data storage interface 460 may be an interface for a data storage device accessible via an ATA protocol such as a hard drive. Data storage interface 460 may comprise a command interpreter 465, an ATA command processor 470, an interrupt generator 475, a medium writer 485, a medium reader 490, and an access status register 495. Command interpreter 465 may receive a command from host interface 410 via the command line 450 and identify bits that indicate the transaction will include a large data transfer that comprises an ATA command.

In response to receipt of the data transfer, ATA command processor 470 may process the ATA command to read data from the data storage medium via medium reader 490 or write data to the data storage medium via medium writer 485. Upon completion of the access to the data storage medium, data storage interface 460 may store an access status in access status register 495 and interrupt generator 475 may generate an interrupt on the command line 450 to indicate that data storage interface 460 is ready to return a completion for the transaction. Data storage interface 460 may then transmit the completion, which includes the access status from access status register 495, to host interface 410. In many embodiments, the completion comprises a transfer of data across data lines 452. In further embodiments, the command line 450 may be utilized to transmit at least some of the data.

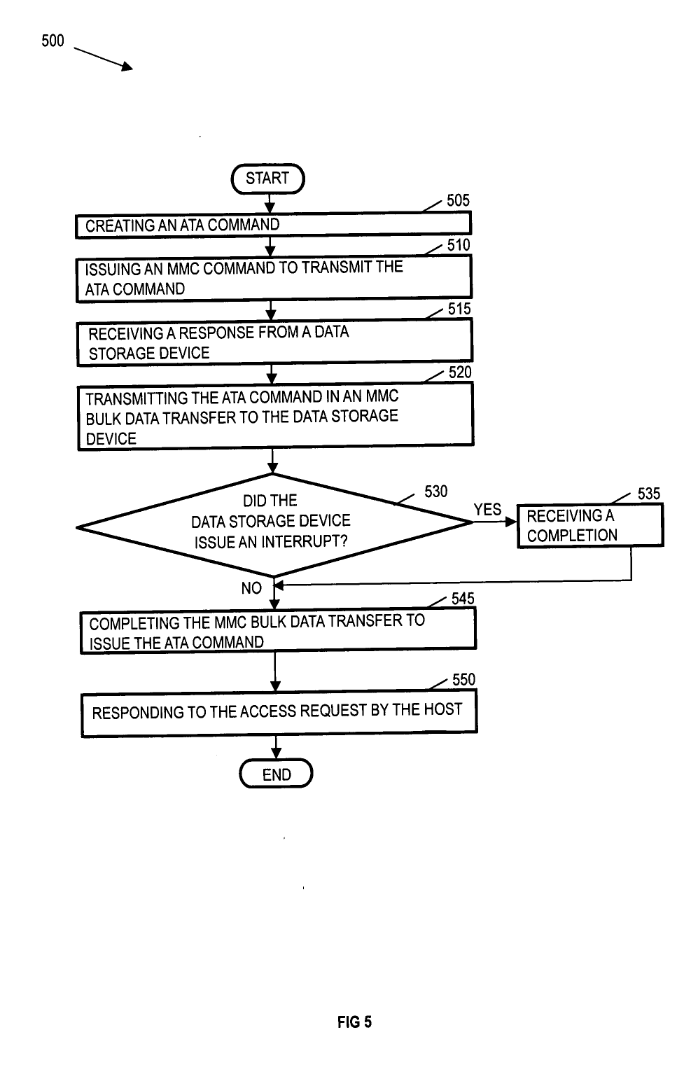

FIG. 5 depicts a flowchart 500 of an embodiment of a host such as the host in FIG. 1 interacting with a data storage device on a CE-ATA interface. Flow chart 500 begins with creating an ATA command (element 505). In particular, the host may interact with a user to select a song to play and, in response, the host may generate an ATA command to retrieve the song from the data storage device. The host may then issue an MMC command to transmit the ATA command (element 510).

After issuing the MMC command, the host may receive a response from the data storage device (element 515). In some embodiments, the host may receive the response after a short delay. The host may then transmit a bulk data transfer or data block comprising the ATA command over the data lines to the data storage device (element 520). For example, the ATA command may reside in 13 of the host's data registers and the host may begin to transmit the registers over, e.g., eight data lines.

Furthermore, once the host receives the response form the data storage device, the command line may remain available for interrupts throughout the remainder of the transaction. As a result, the host may monitor the command line for an interrupt from the data storage device. In response to an interrupt (element 530), the host may prepare to receive and receive a completion for a prior transaction from the data storage device (element 535) before, during, and/or after transmission of the MMC bulk data transfer across the data lines.

On the other hand, if the host does not receive an interrupt (element 530), the host may complete the transfer of the MMC bulk data transfer to allow the ATA command within the bulk data transfer to issue (element 545). The host may then receive a completion in response to the ATA command to conclude the transaction (element 550).

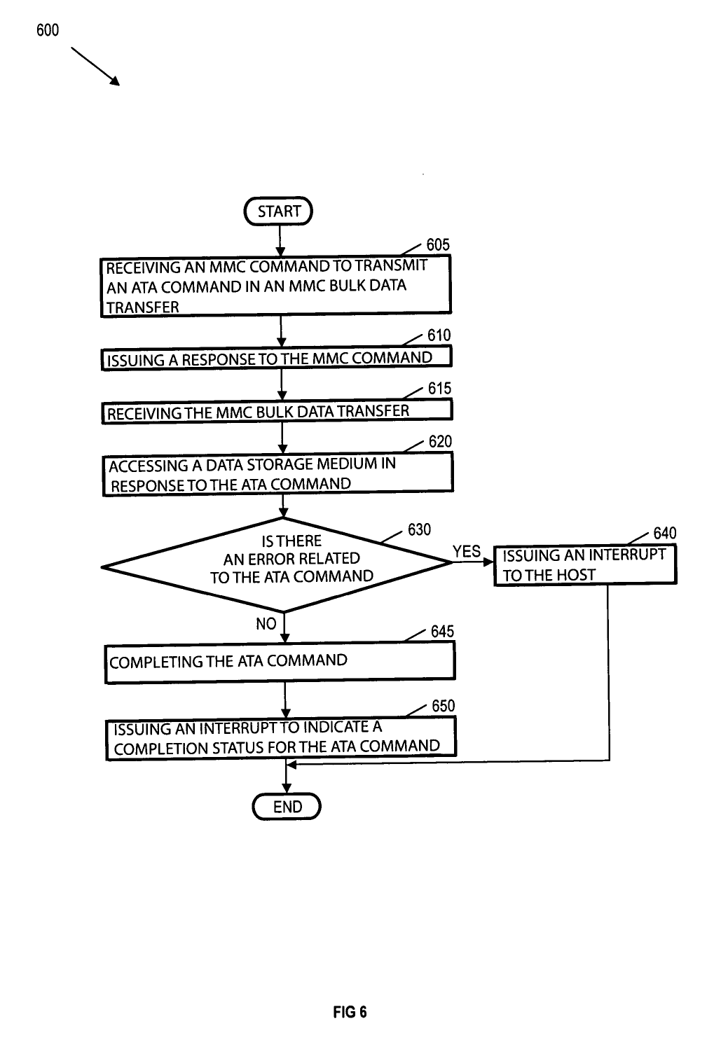

FIG. 6 depicts a flowchart 600 of an embodiment of a data storage device such as the data storage device in FIG. 1 interacting with a host on a CE-ATA interface. Flowchart 600 begins with receiving an MMC command via the command line to transmit an ATA command in an MMC bulk data transfer or data block from the host (element 605). Thereafter, the data storage device may issue a response to the MMC command (element 610). In some embodiments, if an error is encountered in the MMC command as received at the data storage device, the data storage device may respond with an indication of the error.

The data storage device may then receive the MMC bulk data transfer and store the data in data registers or buffers for processing (element 615). The data storage device may process the MMC bulk data transfer to identify and execute the ATA command within the MMC bulk data transfer. Execution of the ATA command may entail accessing one or more storage blocks of a data storage medium (element 620) and storing the data from the storage blocks in data registers for subsequent transmission to the host.

While receiving and/or processing the ATA command, the data storage device may encounter an error related to the ATA command (element 630). In response to the error, the data storage device may issue an interrupt to the host to inform the host of the error. For example, upon receipt of the command from the host, the data storage device may check the CRC bits to validate the command. An error arises if the data storage device is unable to validate the command and, as a result, the data storage device may have to wait for the command to be re-transmitted before responding to and executing the command.

Otherwise, the data storage device may complete the ATA command (element 645) and issue an interrupt to indicate a completion status for the ATA command (element 650). For example, the data storage device may write data to a data storage medium in response to the ATA command and store the status of the write in an access status register, e.g., indicating that the write was successful. Then, the data storage device may issue a completion on the command line that includes the status indicated by the access status register.

Another embodiment of the invention is implemented as a program product for use with a system to perform processes such as the processes described in conjunction with system 100 as illustrated in FIG. 1. The program(s) of the program product defines functions of the embodiments (including the methods described herein) and can be contained on a variety of data and/or signal-bearing media. Illustrative data and/or signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such data and/or signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by a computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates systems and arrangements to interface a data storage device with a host. It is understood that the form of the invention shown and described in the detailed description and the drawings are to be taken merely as examples. It is intended that the following claims be interpreted broadly to embrace all the variations of the embodiments disclosed.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
issuing a command to transfer a data block across an multimedia card (MMC) interface; and
transmitting the data block across the MMC interface between a host and a data storage device, wherein the data block comprises an AT attachment (ATA) command associated with an access of the data storage device.

2. The method of claim 1, further comprising monitoring the command line to detect a pulse indicative of an interrupt.

3. The method of claim 2, wherein monitoring comprises reconfiguring a general purpose input-output to be an input to monitor the command line.

4. The method of claim 2, wherein monitoring comprises reconfiguring the general purpose input-output to be an output to pull up the command line after detection of the pulse.

5. The method of claim 1, wherein transmitting the data block comprises mapping the ATA command into data registers to transmit the ATA command across data lines of the MMC interface.

6. The method of claim 1, wherein transmitting the data block comprises transmitting the data block after the data storage device deasserts a busy signal.

7. The method of claim 1, wherein transmitting the data block comprises transmitting the data block after receipt of a response from the data storage device.

8. A device interface comprising:
a command interpreter to identify a multimedia card (MMC) command associated with transmission of an AT attachment (ATA) command in a data block across an MMC interface; and
a command processor coupled with the MMC interface to access a data storage medium in response to receipt of the ATA command.

9. The device interface of claim 8, further comprising an interrupt generator to pulse a command line of the MMC interface to issue an interrupt.

10. The device interface of claim 9, wherein the interrupt generator comprises logic to pull the command line low for a number of cycles.

11. The device interface of claim 9, wherein the interrupt generator comprises logic to write a bit to a command register of the MMC interface to pull the command line low.

12. The device interface of claim 8, wherein the interrupt generator comprises logic to reconfigure a general purpose input-output (I/O) to issue the interrupt on a command line of the MMC interface.

13. The device interface of claim 8, wherein the command interpreter comprises logic to issue a response to the MMC command.

14. The device interface of claim 8, wherein the command processor comprises logic to access data registers to execute the ATA command.

15. A system comprising:
a host to issue a command to transmit a data block across a multimedia card (MMC) interface, wherein the data block comprises an AT attachment (ATA) command; and
a data storage device to identify the ATA command and to access a data storage medium of the data storage device in response to the ATA command.

16. The system of claim 15, wherein the host comprises an interrupt monitor to monitor a command line of the MMC interface for a voltage transition indicative of an interrupt.

17. The system of claim 15, wherein the host comprises an interrupt monitor to reconfigure a general purpose input-output (I/O) to monitor the MMC interface for the interrupt.

18. The system of claim 15, wherein the host comprises a command creator to map the ATA command into data registers to transmit the ATA command across data lines of the MMC interface.

19. The system of claim 15, wherein the host comprises logic to transmit the data block after the data storage device deasserts a busy signal.

20. The system of claim 15, wherein the host comprises logic to transmit the data block after receipt of a response from the data storage device.

21. The system of claim 15, wherein the data storage device comprises an interrupt generator to pull down the command line to communicate an interrupt to the host.

22. The system of claim 15, wherein the data storage device comprises an interrupt generator to pulse a command line of the MMC interface to issue an interrupt.

23. The system of claim 15, wherein the data storage device comprises a command interpreter to issue a response to the MMC command.

24. The system of claim 15, wherein the data storage device comprises a command processor to access data registers to execute the ATA command.

25. A machine-accessible medium containing instructions, which when executed by a storage device, cause the storage device to perform operations, the operations comprising:
receiving a multimedia card (MMC) command to transfer a data block across an MMC interface from a host; and
accessing a data storage medium in response to an AT attachment (ATA) command embedded in the data block.

26. The machine-accessible medium of claim 25, wherein the operations further comprise pulsing a command line of the MMC interface to issue an interrupt.

27. The machine-accessible medium of claim 26, wherein pulsing the command line comprises pulling the command line low for a period of time.

28. The machine-accessible medium of claim 26, wherein pulsing the command line comprises writing a bit to a command register of the MMC interface.

29. The machine-accessible medium of claim 25, wherein accessing comprises accessing data registers to execute the ATA command.

30. A method comprising:
receiving a multimedia card (MMC) command to transfer a data block across an MMC interface from a host; and
accessing a data storage medium in response to an AT attachment (ATA) command embedded in the data block.

31. The method of claim 30, further comprising pulsing a command line of the MMC interface to issue an interrupt.

32. The method of claim 31, wherein pulsing the command line comprises pulling the command line low for a period of time.

33. The method of claim 31, wherein pulsing the command line comprises writing a bit to a command register of the MMC interface.

34. The method of claim 30, wherein accessing comprises accessing data registers to execute the ATA command.
